(19) United States
(12) Patent Application Publication
(10) Pub. No.: US 2006/0212347 A1
(43) Pub. Date: Sep. 21, 2006

(54) System and method for advertisement delivery in a network system

(75) Inventors: Han Fang, Beijing (CN); Mingjian Yu, Beijing (CN)

Correspondence Address: HAYNES AND BOONE, LLP, 901 MAIN STREET, SUITE 3100, DALLAS, TX, 75202, US

(73) Assignee: 1000 Oaks Hu Lian Technology Development Co., Ltd., Beijing (CN)

(21) Appl. No.: 11/181,119

(22) Filed: Jul. 14, 2005

Related U.S. Application Data
(60) Provisional application No. 60/662,131, filed on Mar. 15, 2005.

(51) Int. Cl. G06Q 30/00

(52) U.S. Cl. 705/14

(57) ABSTRACT

A system, method, and computer-readable medium for providing advertisement data by a network system is provided. A client connects with the network system and receives multimedia data therefrom. The client processes the multimedia data. Advertisement data is output by a plug-in run by the client in response to processing the multimedia data. The plug-in may transmit metrics of the advertisement data to a data processing system.

### RELATED APPLICATION DATA

This patent application claims the benefit of provisional U.S. Patent Application Ser. No. 60/662,231, filed Mar. 15, 2005.

### BACKGROUND

In a client-server network adapted to provide multimedia data, such as streaming content, to clients, advertisements are often inserted into, or displayed in conjunction with, the multimedia data. A multimedia server may provide multimedia data with an advertisement embedded therein, for example at the beginning of the multimedia data, to various client applications that playback the multimedia data by way of a multimedia player plug-in. The multimedia server or another data processing server may collect statistical data on the number of users that have received the advertisement data, for example for billing an advertiser on an advertisement access basis.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a client-server network for providing multimedia services and advertisement delivery and reporting;

FIG. 2 is a diagrammatic representation of an embodiment of multimedia data that may be transmitted via a peer-to-peer network;

FIG. 3 is a diagrammatic representation of an embodiment of an advertisement report that may be conveyed from a plug-in to a network entity for processing or recording of advertisement playback statistical data;

FIG. 4 is a flowchart of an embodiment of a streaming content delivery routine that may facilitate delivery of advertisement data performed by a data processing system;

FIG. 5 is a flowchart of an embodiment of a plug-in processing routine for playback of advertisement data and reporting advertisement metrics in a network system;

FIG. 6 is a flowchart of another embodiment of a plug-in processing routine for playback of advertisement data and reporting advertisement metrics in a network system;

FIG. 7 is a flowchart of another embodiment of a plug-in processing routine for playback of advertisement data and reporting advertisement metrics in a network system; and

FIG. 8 is a flowchart of another embodiment of a plug-in processing routine for playback of advertisement data and reporting advertisement metrics in a network system.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

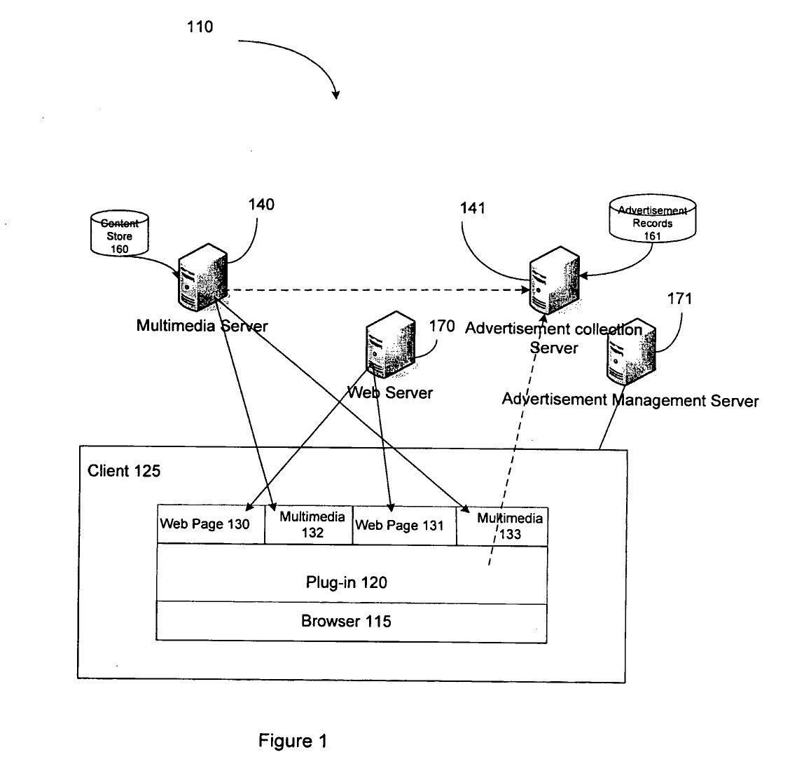

FIG. 1 is a diagrammatic representation of an embodiment of a network system 110 for providing multimedia services and advertisement delivery and reporting. Network system 110 may include one or more web servers 170 that provide content, such as hypertext markup language (HTML) pages, dynamically generated web pages, or other data structures to various clients interconnected with network system 110. Additionally, network system 110 comprises a multimedia server 140 that accesses multimedia content that is transmitted to one or more clients, such as a client 125, in network system 110 by way of, for example, network 100 such as the Internet, a local area network, a wide area network, or another communications network.

A network client 125 may connect with web server 170 and multimedia server 140 for receiving data therefrom. In the illustrative example, web server 170 has conveyed web pages 130 and 131 to client 125. Additionally, multimedia server 140 has conveyed multimedia data 132 and 133 to client 125. For example, multimedia sever 140 may retrieve content, such as multimedia streaming data, from a content store 160 interconnected or otherwise interfaced therewith. Multimedia data 132 and 133 may be processed in association with web page content. For example, web page 130 may include a link or other identifier that references multimedia data 132 and directs client 125 to retrieve and process multimedia data 132 in response to processing web page 130.

Client 125 is adapted for processing of content received from web server 170 and multimedia server 140. For example, client 125 may include browser 115 for processing web pages 130 and 131 and may include a plug-in 120 implemented as a set of computer-readable instructions for playback or other processing of multimedia data 132 and 133. Plug-in 120 may interface with web-browser 115 or other suitable application adapted for processing of data provided by multimedia server 140. For example, plug-in 120 may comprise computer executable instructions that interface with web-browser 115 and extend the functionality of web browser 115 for playback of multimedia data.

Plug-in 120 may be downloaded by client 125 in response to processing of a directive embedded within a web page, such as web page 130. For example, web page 130 may provide an authorization prompt to client 125 so that a user may allow download and installation of plug-in 120 in the event that client 125 does not have the plug-in installed. The computer-readable instructions that define plug-in 120 may be transferred to client 125 from web server 170 or may be delivered to client 125 from another network source. Web pages 130-131 or multimedia data 132-133 may have content embedded therein that provides advertisements, such as image data, audio data, textual data, streaming video and/or audio, or the like, to the client. Alternatively, a web page or multimedia data may provide a reference to an advertisement management server 171 that directs the client to connect with the advertisement server for downloading advertisement data therefrom. Plug-in 120 may then play the advertisement data. An advertisement agreement made between an operator of a media source, such as multimedia server 140, and a merchant may include predefined fees paid to the multimedia server operator based on the exposure of the merchant's advertisement. To this end, an advertisement collection server 141 or other processing entity may be deployed within network system 110 for collection of viewing metrics related to the amount of exposure of an advertisement that has been provided by multimedia server 140. For example, viewing metrics of an advertisement may include the number of presentations that an advertisement has been provided to clients of multimedia server 141, the accumulated time an advertisement has been presented to clients, or another statistic that provides a measure of the presentation quantity of the advertisement that multimedia server 140 has provided. Server 141 may interface with or otherwise access advertisement records 161 for storing or other processing of advertisement metrics. The multimedia server or the client may be configured for reporting viewing metrics (illustratively designated with dashed lines) related to an advertisement.

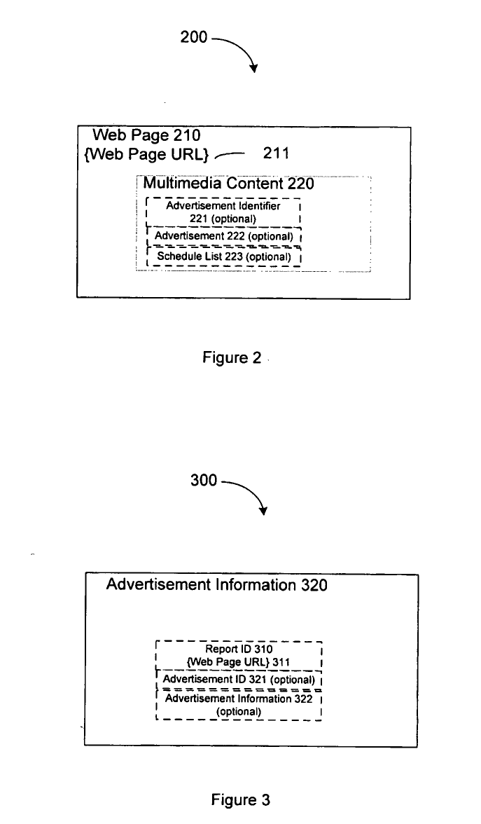

FIG. 2 is a diagrammatic representation of an embodiment of a configuration of data 200 that may be conveyed via a network. Data 200 may comprise a web page 210 that may optionally have embedded multimedia content 220. A uniform resource locator (URL) 211 may be associated with web page 210 that provides a network location of the source of web page 210. Multimedia content 220 may be implemented as streaming content, such as streaming video, audio, or the like. Data 200 may be transmitted to a client, such as client 125, by way of network system 110. For example, data 200 may be transmitted to client 125 from web server 170. Data 200 may be processed by browser 115 run by client 125.

When web page 210 includes embedded multimedia content 220, both web page 210 and multimedia content 220 may be conveyed to client 125 from web server 170. Content of web page 210 may be processed by browser 115. When browser 115 encounters embedded multimedia content 220, plug-in 120 is invoked for processing of the embedded multimedia content.

In another embodiment, web page 210 may have a logical association with multimedia content 220. For example, web page 210 may include connectivity information (such as a network address or uniform resource locator) of multimedia server 140. In this configuration, web page 210 may be downloaded from web server 170. When browser 115 encounters the connectivity information of multimedia server 170 within web page 210, a connection may be established between client 125 and multimedia server 170. Client 125 may then download multimedia content 220 from multimedia server 140. Plug-in 120 may then be invoked for processing of the downloaded multimedia content 220.

Multimedia content 220 optionally includes (illustratively designated with dashed lines) advertisement data 222 and an associated advertisement identifier 221. For example, advertisement data 222 may comprise streaming content, graphical content, textual content, a combination thereof, or another data structure that provides an advertisement message. Advertisement identifier 221 may comprise an index that is associated with advertisement data 222.

Advertisement data 222 may be included in multimedia content 220 and thus may be conveyed to client 125 from web server 140 (in the event multimedia content 220 is conveyed from web server 170) or multimedia server 140 (in the event multimedia content 220 is conveyed from multimedia server 140). In this configuration, advertisement identifier 221 may be included in multimedia content 220 and provides a unique reference for identifying associated advertisement data 222. Alternatively, another data element, such as web page URL 211 may be used for identifying advertisement data 222.

In another embodiment, advertisement data 222 is not included in multimedia content 220. In this configuration, multimedia content 220 may include a data structure that specifies an advertisement is to be played by plug-in 120 and may provide a reference, such as an address of a network entity, from which the plug-in may obtain the advertisement data. For example, multimedia content 220 may include advertisement identifier 221 that specifies associated advertisement data 222 is to be retrieved by client 125 for playback of an advertisement. The plug-in may connect with advertisement management server 171 and download advertisement data 222 therefrom. For example, client 125 may connect with advertisement management server 171 and submit advertisement identifier 221 that is associated with advertisement data 222 to advertisement management server 171. Advertisement management server 171 may retrieve advertisement data 222 from a storage device based on advertisement identifier 221. The advertisement data may then be returned to client 125, and plug-in 120 may then process advertisement data 222.

In another embodiment, multimedia content 220 includes neither advertisement identifier 221 nor advertisement data 222 but may include an optional schedule list 223. Schedule list 223 may include an advertisement identifier and associated advertisement data and scheduling data associated therewith that specifies, for example, a time for processing of the advertisement data. In this configuration, plug-in 120 may process the advertisement data according to scheduling data read from schedule list 223. In a similar manner, schedule list 223 may include respective advertisement data, an associated advertisement identifier, and scheduling data of a plurality of advertisements.

In another embodiment, schedule list may include respective advertisement identifiers of one or more advertisements and associated scheduling data. Plug-in 120 may retrieve advertisement data associated with an advertisement identifier at a scheduled playback time by connecting with a network entity, such as advertisement management server 171, and supplying the advertisement server with the advertisement identifier obtained from the schedule list. The advertisement server may then transmit the advisement data associated with the advertisement identifier, and plug-in 120 may then begin playback of the advertisement data.

In another embodiment, multimedia content 220 may exclude each of the advertisement identifier 221, advertisement data 222, and scheduling list 223. Advertisement playback and reporting may be facilitated in this configuration by client 125 establishing a connection with a network entity, such as advertisement management server 171. Advertisement management server 171 may periodically convey an advertisement event to client 125. An advertisement event may include advertisement data to be processed for playback of an advertisement, an advertisement identifier that may be used by the client for retrieving associated advertisement data from another network entity, a schedule list for directing playback of an advertisement (that may or may not be included within the schedule list), or a combination thereof. Still other implementations may be made for playback of advertisement data and reporting of data related to the advertisement playback as will be recognized by those skilled in the art. For example, one or more advertisements may have advertisement data that is downloaded to client 125 and stored in a file cache or other storage device. Client 125 may obtain a schedule list that defines scheduled playback of one or more advertisements. The client may retrieve one or more advertisements from its local storage in accordance with the playback schedule specified by the schedule list. Advertisement data stored locally by the client may be periodically updated by the client. Other mechanisms for playback of advertisement data may be suitably implemented.

A plug-in run by a client receiving data 200 may be configured to recognize playback of advertisement data 222 and generate playback metrics that provide a quantitative measure of the advertisement playback. For example, playback metrics generated or otherwise obtained by plug-in 120 may comprise a duration of advertisement playback, a beginning time of advertisement playback, an end time of advertisement playback, a number of times the advertisement is played by the client, a combination of playback metrics, or other statistical data that provides a measure of the advertisement playback. Additionally, plug-in 120 may be configured to report playback metrics to a network entity, such as advertisement collection server 141. For example, plug-in 120 may be configured to recognize playback of advertisement data 222 and measure playback metrics related to the playback of the advertisement data. The metrics may then be reported to advertisement collection server 141. Additionally, other data may be reported by plug-in 120 in conjunction with the advertisement metrics. For example, plug-in 120 may report an advertisement identifier associated with the advertisement data, a network address of client 125, a web page URL associated with the advertisement playback, or any other data that may facilitate processing of advertisement playback metrics. Advertisement collection server 141 may then process the advertisement metric, generate additional advertisement metrics, store the advertisement metric in advertisement records 161, or perform another function based on the reported advertisement metric.

FIG. 3 is a diagrammatic representation of an embodiment of an advertisement report 300 that may be conveyed from a plug-in to a network entity for processing or recording of advertisement playback statistical data. Advertisement report 300 may include various advertisement information 320, such as metrics generated, measured, or otherwise obtained, that provides statistical data regarding the playback of an advertisement. Advertisement report 300 may include a report identification (ID) 310 that provides a numerical or other identification that allows a processing entity, such as an advertisement collection server, to distinguish the report from other reports generated by the same or other network clients. The report ID may be generated, for example, by plug-in 120 as a numerical identifier. Alternatively, a web page URL 311 of a web page associated with playback of the advertisement may be used as a report ID. Additionally, report 300 may include an advertisement ID 321 assigned or otherwise associated with the advertisement. Advertisement information 322, such as advertisement playback metrics generated, measured, or otherwise obtained, may be included in report 300. Report 300 is preferably generated by plug-in 120 and may be transmitted to a network entity, such as advertisement collection server 170. For example, report 300 may be generated and transmitted after playback of an advertisement by plug-in 120. Alternatively, plug-in 120 may generate one or more advertisement reports periodically at a scheduled time, on command of advertisement collection server 170, or at another suitable time.

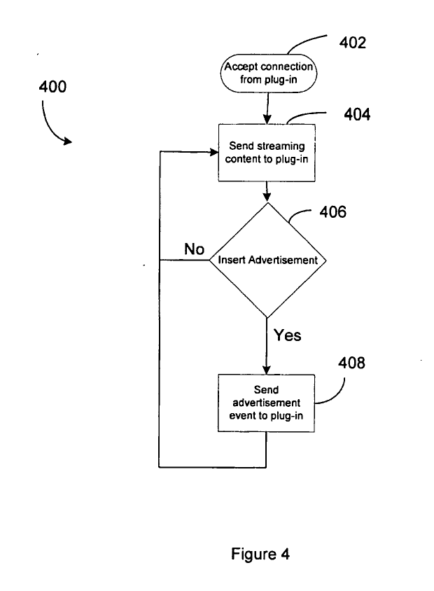

FIG. 4 is a flowchart 400 of an embodiment of a streaming content delivery routine that may facilitate delivery of advertisement data performed by a data processing system. The streaming content delivery routine may be implemented as a set of computer-readable instructions that are executed by a data processing system, such as multimedia server 140 shown in FIG. 1.

The streaming content delivery routine begins by accepting a connection with a client plug-in (step 402). The delivery routine then begins to stream content to the plug-in (step 404). An evaluation may be made to determine if advertisement data is to be inserted into the streaming content (step 406). In the event that advertisement data is not to be inserted into the streaming content, the streaming content delivery routine may continue sending streaming content according to step 404. In the event that advertisement data is to be inserted into the streaming content, advertisement data is then inserted and sent to the client with the streaming content (step 408). The inserted advertisement data may comprise data that defines the advertisement, such as an advertisement implemented as streaming audio or video, graphical advertisement data, textual advertisement data, or other data that may be played or otherwise processed by a plug-in. Alternatively, the advertisement data may comprise an advertisement identifier that specifies a particular advertisement for the plug-in to play. In other implementations, the advertisement data may comprise a schedule list that specifies advertisements and corresponding playback times for the plug-in to process the associated advertisements. In still another embodiment, the advertisement data may specify a URL of a web page that the plug-in may connect with for receipt and playback of an advertisement.

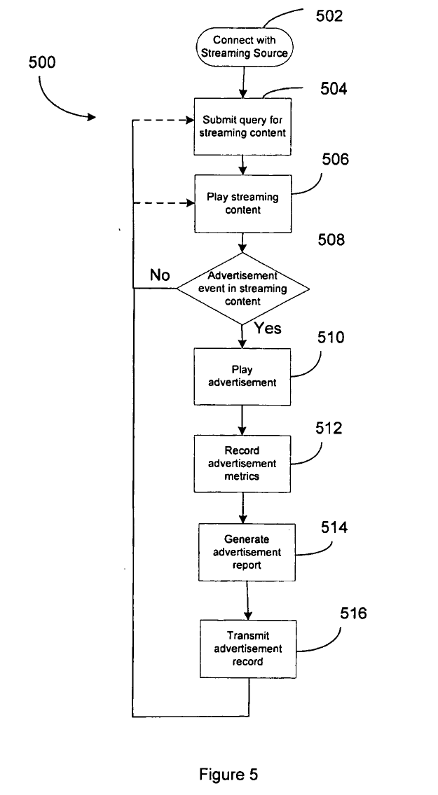

FIG. 5 is a flowchart 500 of an embodiment of a plug-in processing routine for playback of advertisement data and reporting advertisement metrics in a network system. A plug-in connects with a streaming source (step 502), and submits a query for streaming content (step 504). The client plug-in begins playback of the streaming content when sufficient streaming content is received by the plug-in (step 506). The plug-in may evaluate the streaming content to determine if an advertisement event is included in the streaming content (step 508). If no advertisement event is included in the streaming content, the plug-in may submit another request for streaming content according to step 504 or continue playback of the streaming content according to step 506. If it is determined at step 508 that an advertisement event is included in the streaming content, the plug-in may playback the advertisement (step 510) and record or otherwise obtain advertisement metrics regarding playback of the advertisement (step 512). The plug-in may then generate an advertisement report (step 514), and may then transmit the advertisement report to a network entity (step 516) such as advertisement collection server 141. The plug-in may then submit another query for streaming content according to step 504 or may continue playback of the streaming content if additional streaming content remains for playback according to step 506.

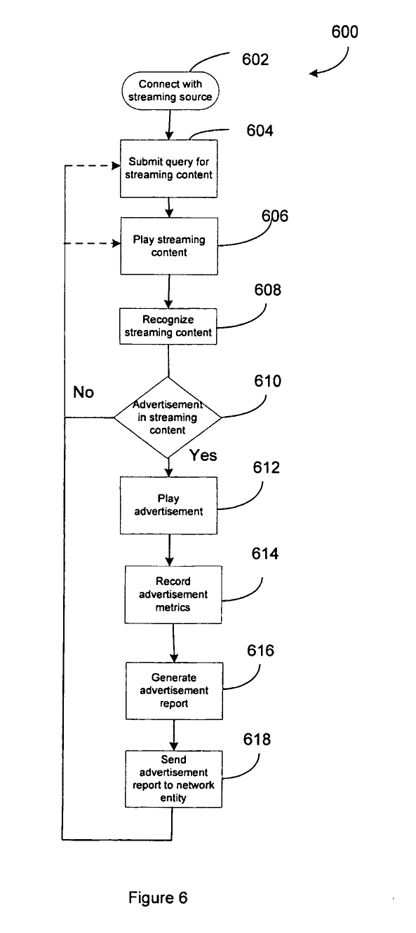

FIG. 6 is a flowchart 600 of an embodiment of another plug-in processing routine for playback of advertisement data and reporting advertisement metrics in a network system. A plug-in connects with a streaming source (step 602), and submits a query for streaming content (step 604). The client plug-in begins playback of the streaming content when sufficient streaming content is received by the plug-in (step 606). The plug-in may evaluate the streaming content to recognize an advertisement event in the streaming content (step 608). For example, a bar code implemented as a predefined numerical sequence embedded in the streaming content may provide an indication of an advertisement event, and the plug-in, upon recognition of the bar code, identifies the streaming content as having an associated advertisement. The plug-in may then evaluate whether the advertisement data is in the streaming content (step 610). If an advertisement is not in the streaming content, the plug-in may again submit a query for streaming content according to step 604 or continue playback of the streaming content according to step 606. If the advertisement is in the streaming content, the plug-in may playback the advertisement (step 612), and record advertisement metrics related to playback of the advertisement (step 614). An advertisement report may then be generated by the plug-in (step 616), and the plug-in may then transmit the advertisement report to a network entity (step 618). Another query for streaming content may then be submitted according to step 604 or the plug-in may continue playback of the streaming content according to step 606.

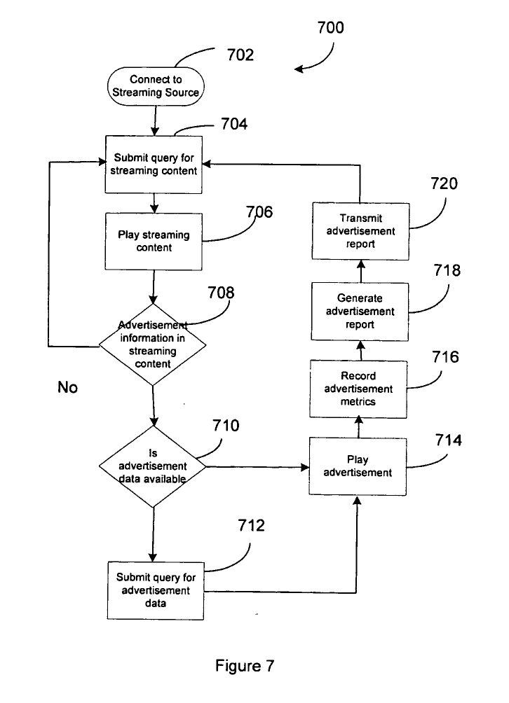

FIG. 7 is a flowchart 700 of an embodiment of another plug-in processing routine for playback of advertisement data and reporting advertisement metrics in a network system. A plug-in connects with a streaming source (step 702), and submits a query for streaming content (step 704). The client plug-in begins playback of the streaming content when sufficient streaming content is received by the plug-in (step 706). An evaluation may then be made to determine if information regarding an advertisement is included in the streaming content (step 708). In the event that advertisement information is not included in the streaming content, another query for streaming content may be submitted by the plug-in according to step 704. If it is determined that advertisement information is included in the streaming content at step 708, and evaluation may then be made to determine if advertisement data is locally available to the plug-in (step 710). For example, the advertisement data may be locally available to the plug-in if the plug-in has previously downloaded the advertisement data and stored the advertisement data in a local file cache, if the advertisement data has been downloaded by the plug-in in a schedule list, if the advertisement data is included in the streaming content, or if the advertisement data is otherwise available to the plug-in in a local storage.

If the advertisement data is locally available to the plug-in, the plug-in may begin playback of the advertisement (step 714). In the event that the advertisement data is not locally available, the plug-in may submit a query for the advertisement data (step 712), and begin playback of the advertisement on receipt thereof according to step 714. Upon playback of the advertisement, the plug-in may record or otherwise obtain advertisement metrics (step 716), and generate an advertisement report (step 718). The plug-in may then establish a connection with a network entity, such as an advertisement collection server, and transmit the advertisement report thereto (step 720). The plug-in may then submit another query for streaming content according to step 704.

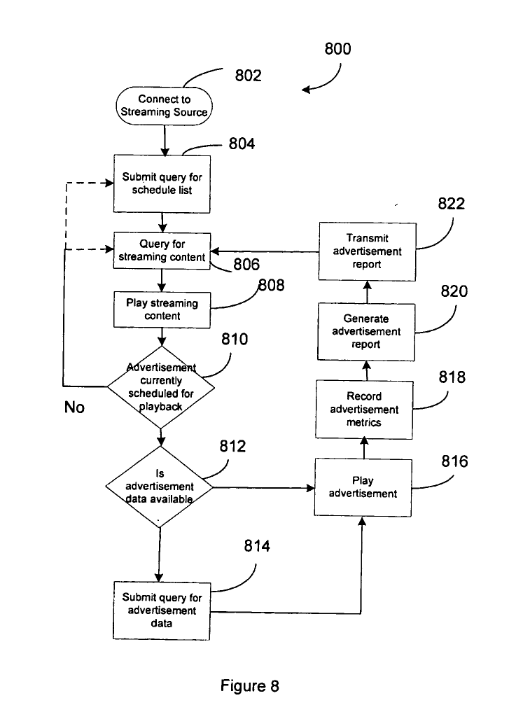

FIG. 8 is a flowchart 800 of an embodiment of another plug-in processing routine for playback of advertisement data and reporting advertisement metrics in a network system. A plug-in connects with a streaming source (step 802), and submits a query for a schedule list (step 804). The plug-in may then submit a query for streaming content (step 806), and thereafter begins playback of the streaming content when sufficient streaming content is received by the plug-in (step 808). An evaluation may then be made to determine if it is time for playback of an advertisement (step 810). If no advertisement is currently scheduled for playback, the plug-in may submit another query for additional streaming content according to step 806 or may continue playing the current streaming content according to step 808.

If it is determined at step 810 that an advertisement is currently scheduled for playback, an evaluation may then be made to determine if advertisement data is locally available to the plug-in (step 812). If the advertisement is locally available to the plug-in, the plug-in may being playback of the scheduled advertisement (step 816). If it is determined at step 812 that the advertisement data is not locally available to the plug-in, the plug-in may then submit a query for the advertisement data (step 814). Upon receipt of the advertisement data, the plug-in may playback the advertisement according to step 816.

Once playback of the advertisement has begun, the plug-in may record or otherwise obtain advertisement metrics (step 818). The plug-in may then generate an advertisement report (step 820) and transmit the report record to a network entity (step 822). The plug-in may then submit a query for additional streaming content according to step 806.

As described, embodiments provide mechanisms for advertisement delivery and reporting in a network system. A plug-in connects with a network node and receives multimedia data therefrom. The plug-in then processes the multimedia data, and outputs advertisement data. The advertisement data may be embedded within the multimedia data, received from an advertisement management server, or retrieved by the plug-in by another mechanism. The plug-in may output the advertisement data upon identification of the advertisement, at a scheduled time, upon a notification event received by the plug-in, or at another time. The plug-in may transmit metrics of the advertisement to a data processing system for processing or storage of advertisement playback metrics.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of providing advertisement data in a network system, comprising:
receiving, by a plug-in, multimedia data;
processing the multimedia data by the plug-in;
outputting, in response to processing the multimedia data, advertisement data by the plug-in; and
transmitting metrics of the advertisement data to a data processing system.

2. The method of claim 1, wherein receiving the multimedia data further comprises receiving the multimedia data with the advertisement data embedded therein.

3. The method of claim 1, wherein receiving the multimedia data further comprises receiving the multimedia data from a multimedia server.

4. The method of claim 1, further comprising:
connecting, by a web browser, with the network system;
receiving a web page which includes the plug-in; and
activating, by the web page, the plug-in.

5. The method of claim 4, wherein transmitting the metrics further comprises transmitting an identifier of the web page with the metrics to the data processing system.

6. The method of claim 1, further comprising:
recognizing, by the plug-in, an identifier of the advertisement data in the multimedia data;
connecting with an advertisement management server; and
receiving the advertisement data from the advertisement management server.

7. The method of claim 1, further comprising:
connecting with an advertisement management server; and
receiving an advertisement notification from then advertisement management server, wherein outputting the advertisement data is performed in response to receiving the advertisement notification.

8. The method of claim 1, further comprising:
connecting with an advertisement management server; and
receiving an advertisement schedule from the advertisement management server, wherein outputting the advertisement data is performed according to the advertisement schedule.

9. The method of claim 8, wherein receiving the advertisement schedule further comprises receiving the advertisement data with the advertisement schedule.

10. The method of claim 1, wherein transmitting metrics further comprises transmitting at least one of a number of times the advertisement data has been played, a playback duration of the advertisement data, a network address of the client, regional information derived from the network address, and a playback beginning time and a playback end time of the advertisement data.

11. A computer-readable medium having computer-executable instructions for execution by a processing system, the computer-executable instructions for providing advertisement data in a network system, comprising:
instructions that receive multimedia data from a multimedia server;
instructions that process the multimedia data by a plug-in;
instructions that output advertisement data in response to processing of the multimedia data; and
instructions that transmit metrics of the advertisement data to a data processing system.

12. The computer-readable medium of claim 11, wherein the instructions that receive the multimedia data receive the advertisement data embedded within the multimedia data.

13. The computer-readable medium of claim 11, further comprising instructions that receive a web page which includes the plug-in, wherein the instructions that transmit the metrics transmit an identifier of the web page with the metrics to the data processing system.

14. The computer-readable medium of claim 11, wherein the instructions that output the advertisement data recognize an identifier of the advertisement data in the multimedia data, the computer-readable medium further comprising:
instructions that connect with an advertisement management server; and
instructions that receive the advertisement data from the advertisement management server.

15. The computer-readable medium of claim 11, further comprising:
instructions that connect with an advertisement management server; and
instructions that receive an advertisement notification from the advertisement management server, and wherein the instructions that output the advertisement data operate in response to receipt of the advertisement notification.

16. The computer-readable of claim 11, further comprising:
instructions that connect with an advertisement management server; and
instructions that receive an advertisement schedule from the advertisement management server, wherein the instructions that output the advertisement data operate according to the advertisement schedule.

17. The computer-readable medium of claim 16, wherein the instructions that receive the advertisement schedule receive the advertisement data with the advertisement schedule.

18. A network system for providing advertisements to clients, comprising:
a communications network;
a multimedia server connected with the communications network that transmits multimedia data to the communications network; and
a client connected with the communications network that runs a browser application and a plug-in to the browser application and receives the multimedia data, wherein the plug-in outputs advertisement data in response to processing the multimedia data, and wherein the plug-in transmits metrics of the advertisement data to a data processing system.

19. The network system of claim 18, wherein the client receives a web page that includes the plug-in.

20. The network system of claim 19, wherein transmitting the metrics further comprises transmitting an identifier of the web page with the metrics to the data processing system.

21. The network system of claim 18, wherein the plug-in recognizes an identifier of the advertisement data in the multimedia data, connects with an advertisement management server, and receives the advertisement data from the advertisement management server.

22. A method of providing advertisement data by a network system, comprising:
obtaining, by a multimedia server, multimedia data;
inserting, by the multimedia server, an advertisement indication into the multimedia data;
connecting with at least one client in the network system; and
transmitting the multimedia data having the inserted advertisement indication to the at least one client.

23. The method of claim 22, wherein inserting the advertisement indication further comprises inserting advertisement data into the multimedia data.

24. The method of claim 22, wherein inserting the advertisement indication further comprises inserting an advertisement identifier into the multimedia data.

25. The method of claim 24, wherein inserting the advertisement identifier further comprises inserting the advertisement data with the advertisement identifier.

26. The method of claim 25, wherein the advisement identifier comprises an index to the advertisement data that is stored on an advertisement management server.
